(19) United States
(12) Patent Application Publication
(10) Pub. No.: US 2019/0001366 A1
(43) Pub. Date: Jan. 3, 2019

(54) AEROSOL GENERATOR DEVICE AND NEBULIZER SYSTEM WITH SUCH A DEVICE

(71) Applicant: KONINKLIJKE PHILIPS N.V., EINDHOVEN (NL)

(72) Inventor: DIRK ERNEST VON HOLLEN, EINDHOVEN (NL)

(21) Appl. No.: 16/064,474

(22) PCT Filed: Dec. 14, 2016
(86) PCT No.: PCT/IB2016/057596

§ 371 Date: Jun. 21, 2018

Related U.S. Application Data
(60) Provisional application No. 62/271,424, filed on Dec. 28, 2015.

(51) Int. Cl. B05B 17/00; B05B 17/06; B05B 7/00

(52) U.S. Cl. CPC B05B 17/0646; B05B 7/0075; B05B 17/0653

(57) ABSTRACT

The present invention relates to aerosol generation. In order to provide an improved way of protecting and sealing of a vibrating element, an aerosol generator device (10) for a nebulizer is provided. The aerosol generator device comprises a base structure (12), a mesh (14) with a plurality of apertures, and a vibrating element (16). The vibrating element is a piezo-element arranged to generate an oscillating movement. The piezo-element is connected to the base structure to transfer the oscillating movement as vibrational movement to the base structure. Further, the mesh is mounted to the base structure, and the vibrational movement is transferred to the mesh in order to generate a plurality of small droplets to form an aerosol when supplied by a fluid. An encapsulation (18) of the piezo-element is provided to provide a sealing of the piezo-element. The encapsulation is provided as a three-dimensional casing structure rigidly connected to the base structure while leaving a distance space (20) between an inner side of the casing structure and the piezo-element.

### FIELD OF THE INVENTION

The present invention relates to aerosol generation, and relates in particular to an aerosol generator device and to a nebulizer system.

### BACKGROUND OF THE INVENTION

In a nebulizer, an aerosol is generated by providing small droplets of a liquid into an airstream to generate mist. For example, for the application of medical drugs, nebulized inhalation therapies are applied. The mist or aerosol droplet medication is carried along with an air-flow, which is inhaled by the patient. For the atomization of the liquid, compressed air, ultrasonic or mesh droplet generators are provided. In a mesh droplet generator, a mesh is vibrated and the liquid is forced through the mesh component that contains a single or multiple nozzles or apertures. The fluid exiting the apertures breaks into a stream of aerosol droplets. The aerosol generator system may be mounted to a structure for support as part of nebulizer. Further, a fluid has to be supplied to the surface of the vibrating mesh. In cases where a vibration generating element has to be protected from contact with the liquid, silicone overmolding may be provided. For example, U.S. Pat. No. 6,554,201 describes a silicone overmolding. However, it has been shown that the silicone overmolding does not bond to surfaces well and requires the use of primers or additives in order to provide a watertight seal.

### SUMMARY OF THE INVENTION

There may thus be a need to provide an improved way of protecting and sealing of a vibrating element.

The object of the present invention is solved by the subject-matter of the independent claims, wherein further embodiments are incorporated in the dependent claims. It should be noted that the following described aspects of the invention apply for the aerosol generator device and also for the nebulizer system.

According to the present invention, an aerosol generator device for a nebulizer is provided. The aerosol generator device comprises a base structure, a mesh with a plurality of apertures and a vibrating element. The vibrating element is a piezo-element arranged to generate an oscillating movement. The piezo-element is connected to the base structure to transfer the oscillating movement as vibrational movement to the base structure. The mesh is mounted to or integrated as part of the base structure and the vibrational movement is transferred to the mesh in order to generate a plurality of small droplets to form an aerosol for inhalation purposes. An encapsulation of the piezo-element is provided to provide a sealing of the piezo-element. The encapsulation is provided as a three-dimensional casing structure rigidly connected to the base structure while leaving a distance space between an inner side of the casing structure and the piezo-element.

The three-dimensional casing structure can also be referred to as three-dimensional housing structure. The encapsulation, when assembled to the base structure, provides a watertight seal.

In an example, the casing structure is a shield that does not engage with any surface of the piezo-element, i.e. the casing structure does not come into contact with the piezo-element.

The three-dimensional casing structure provides a cover of the piezo-element. The term “nebulizer” relates to an apparatus provided to generate an aerosol, for example for inhalation purposes.

In an example, the aerosol is provided for inhalation purposes. In another example, the aerosol is provided for another purpose, such as in a HVAC (heating, ventilation and air conditioning) system or apparatus for humidification.

The provision of a three-dimensional casing structure that still leaves a distance space to the piezo-element reduces the materials that are in direct contact with the piezo-element. The piezo-element is still protected due to the encapsulation; but since the absence of further contact with further elements, the vibration force generated can be used for the vibration of the mesh. The fixation of the casing structure to the base structure allows to form a watertight seal and provides a long-lasting seal. The casing structure is hence providing a shield in such a way that it does not engage with any surface of the piezo-element, but is attached to the base structure, for example a washer platform. Due to the distance space and material flexibility, the impact of the vibration generation to the housing structure, i.e. the encapsulation structure, is reduced to a minimum and thus the sealing feature is improved.

According to an example, the base structure is a flat or three-dimensional structure, and the three-dimensional casing structure is rigidly connected to the base structure on only one side of the two sides of the base structure.

This further improves the fixation and thus the sealing of the encapsulation.

According to an example, the three-dimensional casing structure provides a pocket at least partly around the piezo-element and allows access of electrical connections to the piezo-element; the pocket is watertight.

As a result, the sealing capability, while still leaving enough access to the piezo-element, is further improved.

According to an example, the casing structure is provided as a plastic film, a metallic film, or as an injection molded or thermoformed or stamped structure.

The plastic film may be provided as a thin plastic film, and the metallic film may be provided as a thin metallic film.

The term “thin” refers to the thickness of the encapsulation, which may or may not be a uniform thickness. The thickness is determined by the ability to form a pocket which does not collapse when subject to over-molding process or when a force is applied evenly or unevenly across the top surface. The thickness is also defined with the ability to minimally impact restriction of the piezo-element when attached to the base structure and mesh.

According to an example, the casing structure is formed from transparent material to allow UV light to pass through, and the casing structure is attached to the base structure with an adhesive that is UV light activated.

This facilitates the mounting procedure and further improves the sealing capacities of the encapsulation.

According to an example, the base structure is a circular washer and the piezo-element is having a circular shape.

In an example, the mesh is flat. In another example, the mesh is dome-shaped. In another example the mesh is part of the base structure. The provision of a circular structure improves the vibrational impact on the mesh.

According an example, an enclosure is provided that at least partly encloses the three-dimensional casing structure. In an example, the enclosure is around a circular piezo is rigidly connected on a distance from the inner and outer diameters of the circular piezo.

Hence, a further protection of the encapsulation is provided, and the encapsulation can primarily be directed to form a watertight seal around the piezo-element.

According to an example, the enclosure is provided as a housing at least partly enclosing the three-dimensional casing structure. The housing provides a clamping force urging the three-dimensional casing structure against the base structure.

This further improves the sealing capacities and thus further improves the shielding and isolation of the vibrational element in form of the piezo-element.

In an example, the housing encompasses the base structure and at least one compressed member is arranged between the housing and the base structure.

The force urging the three-dimensional casing structure against the base structure can be provided with or without use of adhesive. The housing can be a rigid housing. For example, the compressed member is made from closed cell foam providing the biasing force to urge the three-dimensional casing structure against the base structure.

According to an example, the enclosure is provided as an overmold at least partly covering the three-dimensional casing structure.

In an example, the piezo-element is arranged on one side of the base structure and the overmold also encloses the outer periphery of the base structure and at least a part of the opposite side of the base structure.

In an example, the overmold is made from silicone or TPE (thermoplastic elastomer). For example, the overmold is provided to encapsulate a portion of the casing.

According to the example, the TPE when overmolded with certain plastics or metals can produce a molecular bond without the use of additional adhesives.

In an example, the encapsulation, piezo-element and separate mesh or encapsulation and piezo-element, are attached using the same adhesive or epoxy system. The piezo-element may employ a wraparound electrode and does not need the use of conductive adhesive.

In another example, the encapsulation contains an additional feature to improve flexibility such as a relieve or bellows.

In another example, the three-dimensional casing structure bends or flexes when permanently connected to the base structure.

In another example, the three-dimensional casing structure is fabricate of the same mesh material and apertures to form a single component.

According to the invention, also a nebulizer system is provided that comprises an air-flow path with an air inlet and an air outlet, and a fluid reservoir is provided to accommodate a liquid, from which small droplets are to be generated in order to form an aerosol. Further, an aerosol generator device according to one of the above-mentioned examples is provided. The fluid reservoir is arranged adjacent the aerosol generator device such that the mesh is in contact with the fluid. The aerosol generator device is arranged in fluid communication with the air-flow path. The piezo-element is sealed off against the fluid reservoir and the air flow path.

In another nebulizer configuration the fluid reservoir is arranged to meter liquid to the aerosol generator through a conduit which can be periodically closed to stop fluid flow or remain open.

According to an aspect, a sealing is provided in form of an encapsulation that still leaves some distance on the inner side to the piezo-element as the vibration generating element. The encapsulation is connected to the base structure, to which the piezo-element is also connected. Hence, a watertight seal is provided that isolates or shields the piezo-element from a liquid from which droplets are to be generated, but the seal still provides space for the vibrating element to vibrate without touching or urging against the seal.

The aerosol generator as part of a nebulizer is mounted within a housing structure which may or may not require a secondary material such as an overmold to contact with the top surface of the encapsulation.

These and other aspects of the present invention will become apparent from and be elucidated with reference to the embodiments described hereinafter.

### BRIEF DESCRIPTION OF THE DRAWINGS

Exemplary embodiments of the invention will be described in the following with reference to the following drawings:

FIG. 1a shows a schematic cross-section through an example of an aerosol generator device;

FIG. 1b shows a further example of an aerosol generator device;

FIG. 2 shows a still further example of an aerosol generator device in a schematic cross-section;

FIG. 3 shows a further cross-section through a further example of an aerosol generator device;

FIG. 4 shows a still further example of an aerosol generator device in a schematic cross-section;

FIG. 5a shows a cross-section through a further example of an aerosol generator device;

FIG. 5b shows a cross-section through another example of an aerosol generator device;

FIG. 6a shows a cross-section through a further example of an aerosol generator device in a perspective illustration;

FIG. 6b shows a part of a further example of an aerosol generator device; and

FIG. 7 shows an example of a nebulizer system in a schematic cross-section.

### DETAILED DESCRIPTION OF EMBODIMENTS

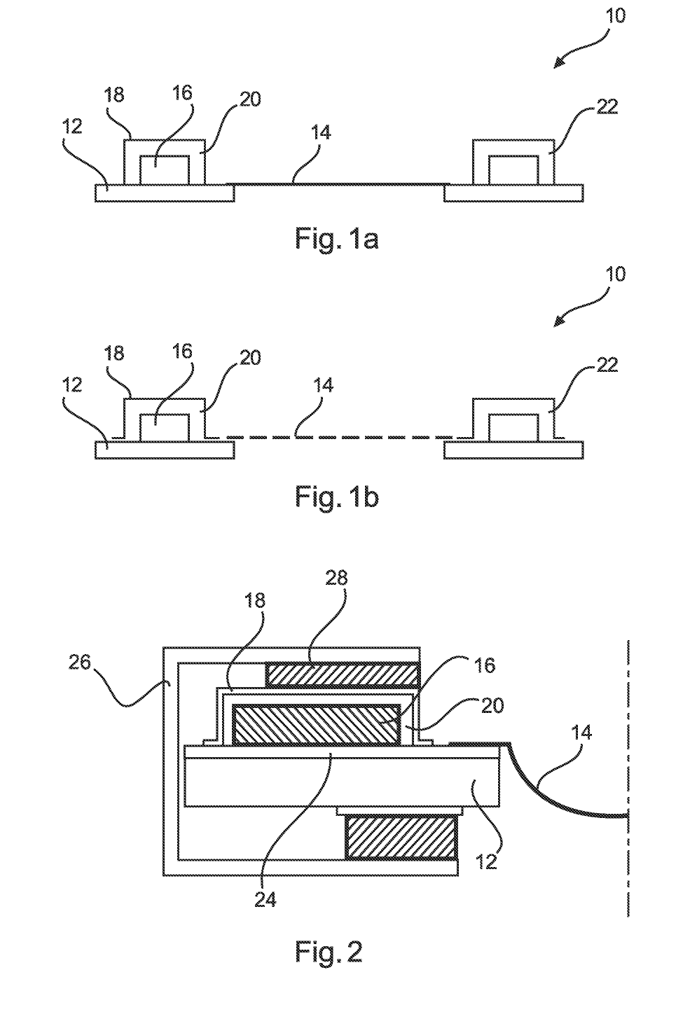

FIG. 1a shows an aerosol generator device 10 for a nebulizer. The aerosol generator device comprises a base structure 12 and a mesh 14 with a plurality of apertures. (It must be noted that in the following, the apertures are not further shown and described.) Further, a vibrating element 16 is provided. The vibrating element 16 is a piezo-element arranged to generate an oscillating movement. The piezo-element is connected to the base structure 12 to transfer the oscillating movement as vibrational movement to the base structure. The mesh 14 is mounted to the base structure 12 and the vibrational movement is transferred further to the mesh in order to generate a plurality of small droplets to form an aerosol.

Still further, an encapsulation 18 of the piezo-element is provided to provide a sealing of the piezo-element. The encapsulation 18 is provided as a three-dimensional casing structure rigidly connected to the base structure 12. However, a distance space 20 is provided between an inner side of the casing structure and the piezo-element. It must be noted that the mesh 14 may be provided as a flat mesh structure, or as a three-dimensionally shaped structure, such as a dome-shaped mesh. Furthermore, the mesh provides an aperture structure having a plurality of apertures. It is further provided that the mesh can be a mesh structure with mesh members, or a grid structure with grid members, or may be a closed structure having a plurality of openings as the apertures.

In an example, the base structure 12 is a flat structure. In another example, the base structure 12 is a three-dimensional structure.

The three-dimensional casing structure, i.e. the encapsulation 18, is rigidly connected to the base structure 12 on only one side of the two sides of the base structure 12, as for example shown in FIG. 1a.

According to a further option, the three-dimensional casing structure provides a pocket 22, as indicated in FIG. 1a as an option, at least partly around the piezo-element and allows access of electrical connections to the piezo-element (not further shown). The pocket 22 is formed to be watertight.

As indicated above, in an example, the casing structure is provided as a plastic film. In another option, the casing structure is provided as a metallic film. In a further example, the casing structure is injection molded.

According to a further option, the casing structure is formed from transparent material to allow UV light to pass through. The casing structure is attached to the base structure 12 with an adhesive that is UV (ultraviolet) light activated.

FIG. 1b shows another example, in which the encapsulation 18 and the mesh 14 are formed as a single piece construction and same material.

FIG. 2 shows a further example, according to which the piezo-element, i.e. the vibrating element 16 is connected to the base structure, for example provided in form of a washer, with a layer of epoxy 24. Further, the encapsulation 18 is provided as a plastic encapsulation cover. The distance space 20 is also provided. As an option, an enclosure 26 is provided that at least partly encloses the three-dimensional casing structure.

As an option, the mesh 14 is provided as a domed mesh.

As can be seen, optionally the enclosure 26 is provided as a housing at least partly enclosing the three-dimensional casing structure. The housing, i.e. the enclosure 26, provides a clamping force urging the three-dimensional casing structure against the base structure 12. Thus, as a further option, the housing encompasses the base structure and at least one compressed member 28 may be arranged between the housing and the base structure, for example between the enclosure 26 and the encapsulation 18. For example, the compressed member is a closed cell foam attached by adhesive.

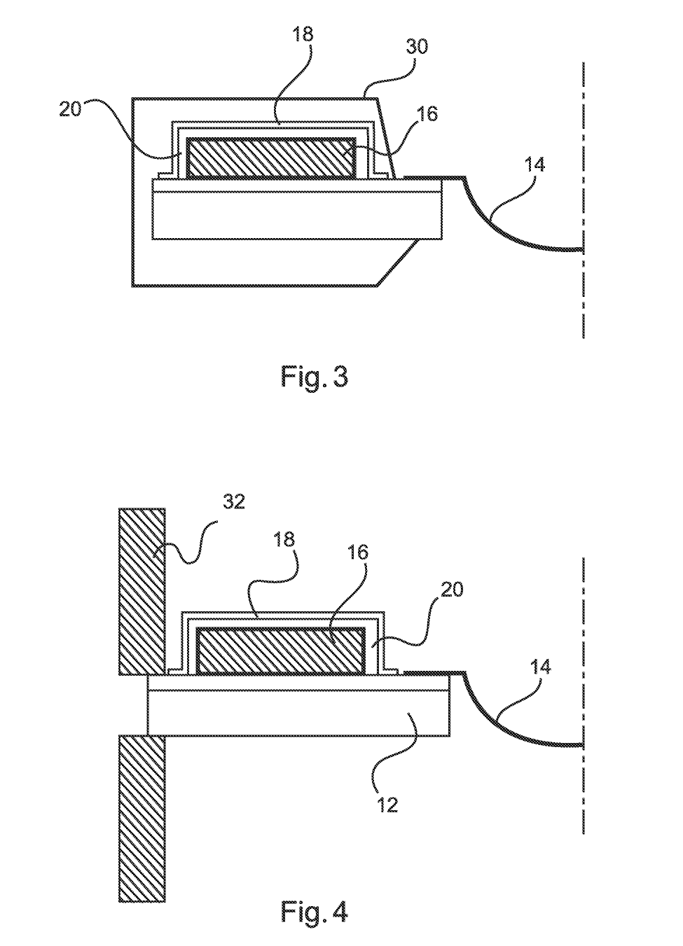

In FIG. 3, a further example is illustrated, according to which the enclosure 26 is provided as an overmold 30, for example made of silicone or TPE. Hence, according to the option shown in FIG. 3, the enclosure at least partly covers the three-dimensional casing structure of the encapsulation 18.

According to an option, the piezo-element is arranged on one side of the base structure and the overmold also encloses the outer periphery of the base structure and at least a part of the opposite side of the base structure, as shown as an option in FIG. 3.

FIG. 4 shows a further example, in which the piezo-element of the vibrating element 16 is attached to the base structure 12 in form of a washer by an adhesive, for example an epoxy layer. Further, the encapsulation 18 is also attached to the base structure 12 by the epoxy layer. Still further, also the mesh 14 may be attached to the base structure 12 by the epoxy layer. Still further, it is shown that the base structure 12 is mounted directly to a housing 32 of an apparatus.

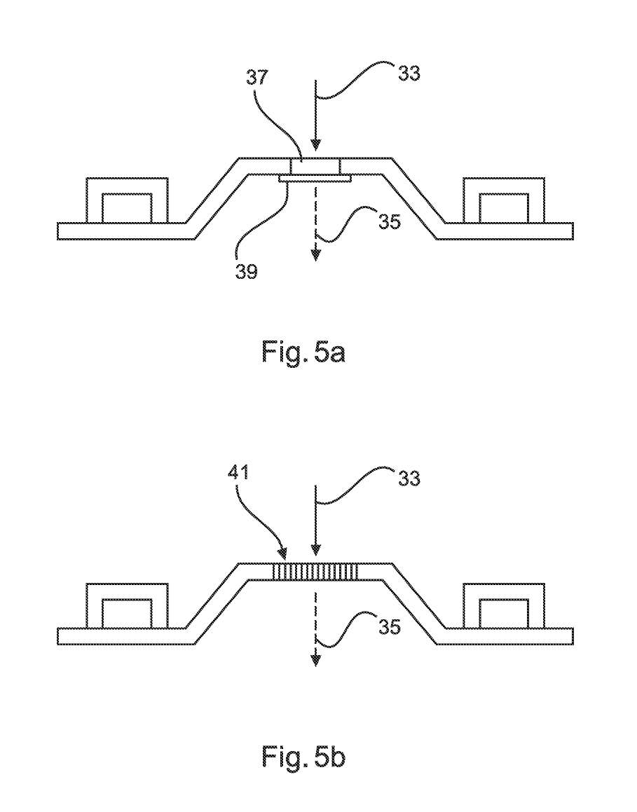

In FIGS. 5a and 5b, a first arrow 33 indicates a liquid to be passed through the mesh, and a second arrow 35 indicates a resulting aerosol.

FIG. 5a shows an example of the mesh formed by an opening 37 of a base covered by a mesh segment 39.

FIG. 5b shows another example of the mesh formed by a plurality of openings 41 in a base. In other words, the mesh is part of the base structure. In an example, the material is the same. The thickness of the base structure may be uniform or may vary.

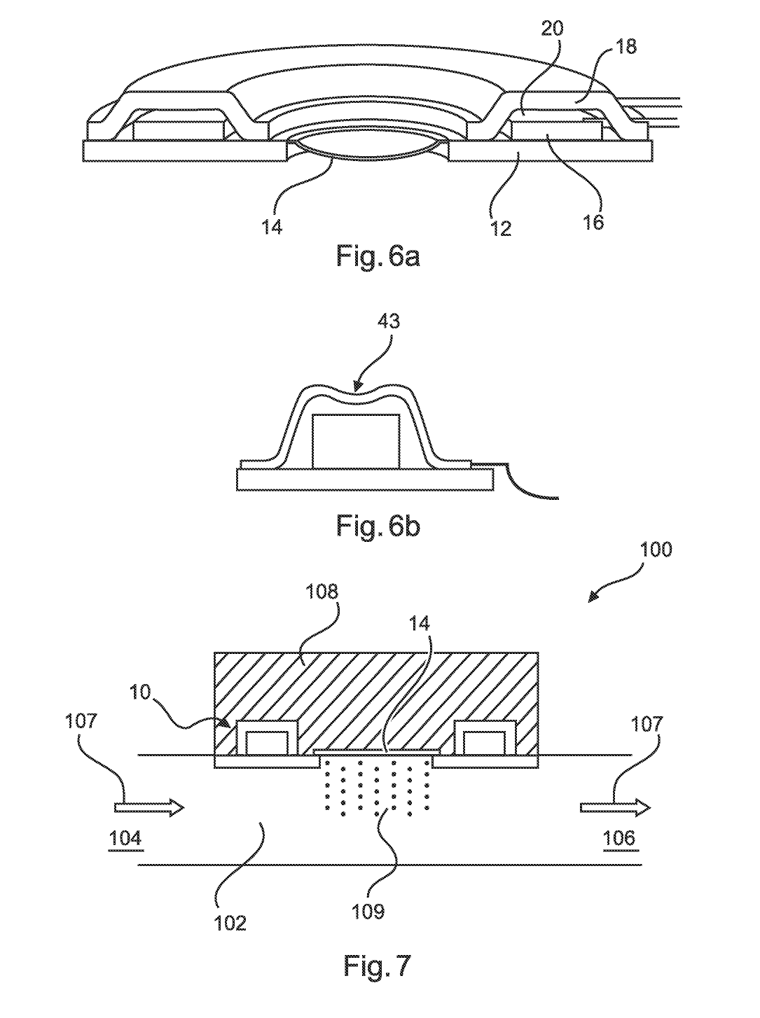

FIG. 6a shows a further option, according to which the vibration element 16 in form of the piezo-element is connected to the washer forming the base structure 12. Further, the mesh 14 is a domed mesh attached to the base structure. A three-dimensional plastic structure forms the encapsulation 18, and the plastic structure is attached to the washer.

According to an option, the base structure 12 is a circular washer and the piezo-element is also having a circular shape.

FIG. 6b shows another example, where the encapsulation contains an additional feature to improve flexibility such as a relieve or bellows 43.

FIG. 7 shows a schematic cross-section through a nebulizer system 100 that comprises an air-flow path 102, having an air inlet 104 and an air outlet 106. Arrows 107 indicate a possible airstream. Further, a fluid reservoir 108 is provided to accommodate a liquid from which small droplets are to be generated in order to form an aerosol. The small droplets are indicated with a dotted structure 109. Further, an example of the aerosol generator device 10 according to one of the above-mentioned examples is provided. The fluid reservoir 108 is arranged adjacent the aerosol generator device such that the mesh is in contact with the fluid. The aerosol generator device is arranged in fluid communication with the air-flow path 102. The piezo-element is sealed off against the fluid reservoir and the air flow path.

It has to be noted that embodiments of the invention are described with reference to different subject matters. In particular, some embodiments are described with reference to aerosol generator device claims whereas other embodiments are described with reference to the nebulizer system claims. However, a person skilled in the art will gather from the above and the following description that, unless otherwise notified, in addition to any combination of features belonging to one type of subject matter, also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope.

1. An aerosol generator device for a nebulizer, the aerosol generator device comprising:
a base structure;
a mesh with a plurality of apertures; and
a vibrating element;
wherein the vibrating element is a piezo-element arranged to generate an oscillating movement;
wherein the piezo-element is connected to the base structure to transfer the oscillating movement as vibrational movement to the base structure;
wherein the mesh is mounted to or integrated as part of the base structure, and the vibrational movement is transferred to the mesh in order to generate a plurality of small droplets to form an aerosol;
wherein an encapsulation of the piezo-element is provided to provide a sealing of the piezo-element;
wherein the encapsulation is provided as a three-dimensional casing structure rigidly connected to the base structure while leaving a distance space between an inner side of the casing structure and the piezo-element.

2. Aerosol generator device according to claim 1, wherein the base structure is a flat or three-dimensional structure, and the three-dimensional casing structure is rigidly connected to the base structure on only one side of the two sides of the base structure.

3. Aerosol generator device according to claim 1, wherein the three-dimensional casing structure provides a pocket at least partly around the piezo-element and allows access of electrical connections to the piezo-element, which pocket is watertight.

4. Aerosol generator device according to claim 1, wherein the casing structure is provided as:
i) a plastic film;
ii) a metallic film; or
iii) injection molded, thermoformed, or stamped

5. Aerosol generator device according to claim 1, wherein the casing structure is formed from transparent material to allow UV light to pass through; and wherein the casing structure is attached to the base structure with an adhesive that is UV light activated.

6. Aerosol generator device according to claim 1, wherein the base structure is a circular washer, and the piezo-element is having a circular shape.

7. Aerosol generator device according to claim 1, wherein an enclosure is provided that at least partly encloses the three-dimensional casing structure.

8. Aerosol generator device according to claim 1, wherein the enclosure is provided as a housing at least partly enclosing the three-dimensional casing structure; wherein the housing is providing a clamping force urging the three-dimensional casing structure against the base structure; and wherein, preferably, the housing encompasses the base structure; and wherein at least one compressed member is arranged between the housing and the base structure.

9. Aerosol generator device according to claim 1, wherein the enclosure is provided as an overmold at least partly covering the three-dimensional casing structure; and wherein, preferably, the piezo-element is arranged on one side of the base structure; and the overmold also encloses the outer periphery of the base structure and at least a part of the opposite side of the base structure.

10. A nebulizer system comprising:
an air-flow path with an air inlet and an air outlet;
a fluid reservoir provided to accommodate a liquid from which small droplets are to be generated in order to form an aerosol; and
an aerosol generator device according to claim 1,
wherein the fluid reservoir is arranged adjacent the aerosol generator device such that the mesh is in contact with the fluid;
wherein the aerosol generator device is arranged in fluid communication with the air-flow path; and
wherein the piezo-element is sealed off against the fluid reservoir and the air flow path.
